(19) United States
(12) Patent Application Publication
(10) Pub. No.: US 2016/0186930 A1
(43) Pub. Date: Jun. 30, 2016

(54) PRESSURIZED PRODUCT STREAM DELIVERY

(71) Applicant: PRAXAIR TECHNOLOGY, INC., Danbury, CT (US)

(72) Inventors: David Parsnick, Amherst, NY (US); John F. Billingham, Getzville, NY (US); James P. Meagher, Buffalo, NY (US); Brian S. Powell, Williamsville, NY (US)

(21) Appl. No.: 14/907,615

(22) PCT Filed: Feb. 28, 2014
(86) PCT No.: PCT/CN2014/072709

§ 371 Date: Jan. 26, 2016

(51) Int. Cl. F17C 9/02; F17C 13/02

(52) U.S. Cl. CPC F17C 9/02; F17C 13/02; F17C 2227/0135; F17C 2250/03; F17C 2221/011

(57) ABSTRACT

A method and delivery system for delivering a pressurized product stream from an air separation plant in which a liquid stream is pumped by a pump at cryogenic temperature and then heated in a heat exchanger of a flow network to produce the pressurized product stream. The flow network is designed to control flow of the pressurized product stream and to maintain the pressure of the pressurized product stream at a constant design pressure. The design pressure is maintained by sensing pressure of the pressurized product stream and varying the speed of a motor driving the pump to maintain the pressure at the design pressure.

### FIELD OF THE INVENTION

The present invention relates to a method and system for delivering a pressurized product stream from an air separation plant in which a liquid stream, enriched in a component of air separated by the air separation plant through cryogenic distillation, is pumped and then heated by a heat exchanger of the air separation plant. More particularly, the present invention relates to such a method and system in which the liquid stream is pumped by a variable speed motor regulated by a variable speed drive, flow of the pressurized product stream is controlled to maintain the flow at a set point and pressure of the pressurized product stream is controlled by sensing the pressure of the liquid stream after having been pumped and then controlling the speed of the pump with the variable speed drive so that the pressure is maintained at design pressure.

### BACKGROUND OF THE INVENTION

Air is separated in air separation plants by cryogenic rectification to produce products that are enriched in components of the air. In such a separation, the air is compressed and purified of higher boiling impurities such as water vapor, carbon dioxide and hydrocarbons. Thereafter, the air is cooled to a temperature suitable for its rectification within a distillation column system typically having high and low pressure columns that operate at higher and lower pressure ranges, respectively. The incoming compressed and purified air, after having been cooled is introduced into the higher pressure column to separate the nitrogen from the air and thereby produce a nitrogen-rich vapor column overhead and a column bottoms known as crude liquid oxygen or kettle liquid. A stream of the column bottoms is then introduced into the lower pressure column for further refinement into an oxygen-rich liquid column bottoms and another nitrogen-rich vapor column overhead. The columns can be operatively associated in a heat transfer relationship by condensing the nitrogen-rich vapor column overhead of the higher pressure column through indirect heat exchange with the oxygen-rich liquid column bottoms of the lower pressure column. The resulting condensed liquid nitrogen can be used to reflux both the high and low pressure columns.

Streams composed of the oxygen-rich and nitrogen-rich liquids and vapors can be used in cooling the incoming compressed and purified air and then can be taken from the plant as products. Where a product is required at high pressure, typically oxygen, but also possibly nitrogen, a liquid stream can be pumped while still at a cryogenic temperature and then heated to produce the stream at pressure. The heating can take place in heat exchanger arrangements having integrated heat exchangers (capable of processing streams at all process pressures) or alternatively a combination of high and low pressure heat exchangers where process heat exchanger duty is split such that some heat exchangers only process lower pressure streams and can thus be less costly. The integrated or high pressure heat exchanger is used to heat the pressurized liquid stream(s) against a boosted pressure air stream. Depending on the degree of pressurization, the resulting product stream(s) can either be a supercritical fluid or a vapor. It is to be noted that the pressure of the resulting pressurized product stream is required to be maintained at a certain design pressure to be fed into a pipeline or passed to a customer. This requirement is complicated by the fact that air separation plant itself will typically be designed to operate both under a normal operational condition at which the pressurized product is delivered at a predetermined flow rate and a turndown operation condition during which the pressurized product is delivered at a lesser flow rate. This type of operation is particularly useful where there is a cyclical customer demand. The pressurized product stream must, however, be delivered at or above the design pressure at both the normal operational condition and at turndown.

Since the pump operates at a specific speed that practically does not vary, in prior art control systems related to pressurized product delivery, pressure is controlled by a valve situated between the heat exchanger and the pump and flow delivered from the pump is found from the pump performance curve at that fixed speed and discharge pressure. When this flow is greater than that being required based on the flow control, as is particularly the case during turndown or a decrease in demand for the pressurized product by the customer, the flow delivered from the pump will exceed the flow leaving the air separation plant and the pressure upstream of the pressure control valve will increase. The resulting pressure differential across the pump would not be consistent with the reliable and safe operation of the pump. In order to counteract this, a pressure sensor senses the pressure between the outlet and inlet of the pump and when the pressure differential reaches a set point, a recirculation valve is opened to allow some of the pumped liquid stream to be recirculated back to the column, typically the low pressure column in case of an oxygen product. As can be appreciated, this is not a particularly energy efficient system in that the pump adds enthalpy to the recirculated liquid. In order to compensate for this, more plant refrigeration must be generated. This in turn results in increased power consumption for the plant and therefore, increased running costs. Additionally, since the output pressure of the pump can be as high as 1500 psig and the column operates at about 20 psig, the stress on the recirculation valve is severe and represents a point of failure in the plant. Moreover, the valve used to control pressure downstream of the pump is an expensive cryogenic valve that adds to the fabrication costs of the plant.

As will be discussed, the present invention provides a method and system for delivery of a pressurized product from an air separation plant which among other advantages contemplates operation of the delivery system during both design and turndown conditions without recirculation of the pumped liquid and without the use of an expensive cryogenic valve that is used to control pressure.

### SUMMARY OF THE INVENTION

The present invention relates to a method of delivering a pressurized product stream from an air separation plant. In accordance with the invention, a liquid stream is pumped to a design pressure while the liquid stream is at a cryogenic temperature. The liquid stream is enriched in a component of air and produced through cryogenic distillation conducted within the air separation plant. The liquid stream is pumped with a pump driven by a variable speed motor having a speed regulated by a variable speed drive. After having been pumped, the liquid stream is heated in a heat exchanger of the air separation plant to produce the pressurized product stream. The flow rate of the pressurized product stream is controlled with a control valve downstream of the heat exchanger so that a flow rate of the pressurized product stream upstream of the control valve is maintained at a flow rate set point and also, by venting a portion of the pressurized product stream upstream of the flow control valve when the flow control valve is unable to control the flow of the pressurized product stream to achieve the flow rate set point. The pressure of the liquid stream after having been pumped is measured and the speed of the variable speed motor and therefore, the pump is controlled with the variable speed drive in response to the pressure so that the pressure is maintained at the design pressure.

The use of a variable speed drive to control pressure eliminates the use of an expensive cryogenic valve which is otherwise inserted in normal operation downstream of the pump and whose opening is used to control a pressure downstream of the valve. Moreover, the fairly consistent recirculation of the pumped liquid can also be eliminated or significantly reduced versus a fixed speed pump. In this regard, the flow rate set point for the product stream may be set at a design operational level and alternatively, at a turndown operational level where the flow rate is lower than that of the design operational level and during which the air separation plant produces the liquid stream at a lower flow rate than during the design operation level. In the case of a fixed speed pump, the quantity of product being pumped remains at or above the design operational level and flow in excess of that required to be delivered based on the flow controller is recirculated. In the present invention the speed of the pump during turndown is at a lower speed than the speed at the design operational level but that is no less than a minimum speed where the pump is capable of pumping the liquid stream to a maximum pressure that is at least 3.0 percent above the design pressure. The method can be carried out so that during a turndown operational level where the pump is incapable of stably pumping the liquid stream at the design pressure while at the minimum speed, a portion of the liquid stream is recirculated from an outlet to an inlet of the pump in order to obtain the design pressure at the lower product flow rate. In this regard, it is understood herein and in the claims that the recirculation from the outlet to the inlet of the pump need not be a direct recirculation path. It can be for instance, indirect where the liquid is recirculated back to the distillation column system from the outlet of the pump.

In a method in accordance with the present invention, where the design pressure is a supercritical pressure, the pressure is measured within the pressurized product stream, downstream of the heat exchanger. Alternatively, where the design pressure is below a supercritical pressure, the pressure can be measured within the liquid stream, after having been pumped, upstream of the heat exchanger.

The present invention also provides a delivery system for delivering a pressurized product stream from an air separation plant. Such system has a flow network and a control system. The flow network comprises a pump to pump a liquid stream to a design pressure. The pump is positioned within the air separation plant so that the liquid stream is pumped while at a cryogenic temperature. The liquid stream is enriched in a component of air and produced through cryogenic distillation conducted within the air separation plant. A variable speed motor drives the pump and a heat exchanger is connected to the pump and located in the air separation plant to heat the liquid stream and thereby to produce the pressurized product stream. A flow control valve is located downstream of the heat exchanger and a vent control valve is located upstream of the flow control valve. A flow transducer is located upstream of the flow control valve and configured to generate a flow signal referable to the flow rate. The control system is provided with a flow controller responsive to the flow signal and a flow rate set point. The flow controller is configured to generate control signals to control the flow control valve so that a flow rate of the pressurized product stream upstream of the flow control valve is maintained at a flow rate set point and to control the vent control valve to vent a portion of the pressurized product stream when the flow control valve is unable to control the flow of the pressurized product stream to achieve the flow rate set point. Additionally, a means is also provided for measuring pressure of the liquid stream after having been pumped and a means for generating a speed signal in response to the pressure and referable to a pump speed that will maintain the pressure at the design level. The variable speed drive is responsive to the speed signal and configured to control the speed of the variable speed motor and therefore, the pump so that the pressure is maintained at the design pressure.

The flow controller can be provided with an input for the flow rate set point so that the flow rate set point is able to be varied between a design operational level and alternatively, at a turndown operational level where the flow rate is lower than that of the design operational level and during which the air separation plant produces the liquid stream at a lower flow rate than during the design operation level. The variable frequency drive has a minimum speed at which the pump is capable of pumping the liquid stream to a maximum pressure that is at least 3.0 percent above the design pressure and is responsive to speed signal so that during the turndown operational level the pump operates at a lower speed than at the design operational level but no less than the minimum speed. Additionally, a recirculation path can be provided, communicating between an outlet and an inlet of the pump. Again, this recirculation path can be direct or indirect. The recirculation path is provided with a recirculation control valve that when open allows a portion of the liquid stream to recirculate from the outlet to the inlet of the pump. The operation of the recirculation control valve is controlled by a pressure differential indicator controller and a motor power indicating controller. The pressure differential indicator controller is connected to the remotely activated recirculation valve and responsive to a pressure difference between the outlet and an inlet of the pump and a pressure differential set point of the pressure difference. The controller is configured to generate a pressure difference control signal that will open the remotely activated recirculation valve when the pressure difference is above the pressure differential set point. The pressure differential set point being selected such that the recirculation control valve opens to allow the pump to pump the liquid stream at the design pressure while at the minimum speed and at the lower product flow rate of the turndown operational level. The motor power indicating controller is attached to the variable frequency drive and responsive to power drawn by the motor while the pump is at minimum speed and a power set point of the power drawn by the pump. This controller is configured to generate a power control signal that will open the recirculation control valve when the power drawn by the motor is below the power set point. A high select controller is positioned between the remotely activated recirculation valve and the pressure differential indicator controller and the motor power indicating controller and configured to select a higher value of the pressure difference control signal and the power control signal to control the remotely activated recirculation valve.

Where the design pressure is a supercritical pressure, the pressure measuring means can be located within the flow network downstream of the heat exchanger. Alternatively, where the design pressure is below a supercritical pressure, the pressure measuring means can be located within the flow network between the pump and the heat exchanger. Preferably, the pressure measuring means and the speed signal generating means comprise a pressure transducer configured to generate a pressure signal referable to the pressure and a pressure controller responsive to the pressure signal and configured to generate the speed signal The pressure controller has a slower response time than the flow controller and the variable speed drive is responsive to the speed signal so that the speed of the motor and therefore, the pump will vary in response to the speed signal to maintain the pressure at the design level.

In either aspect of the invention, method and system, the component enriching the product stream can be oxygen.

### BRIEF DESCRIPTION OF THE DRAWINGS

Although the specification concludes with claims distinctly pointing out the subject matter that Applicants regard as their invention, it is believed that the invention will be better understood when taken in connection with the accompanying drawings in which:

FIG. 1 is a schematic diagram of a system for carrying out a method in accordance with the present invention in which a pressurized liquid product is delivered from an air separation plant; and

FIG. 2 is an example of graphical representation of a system curve and pump curves at distinct operating speeds.

### DETAILED DESCRIPTION

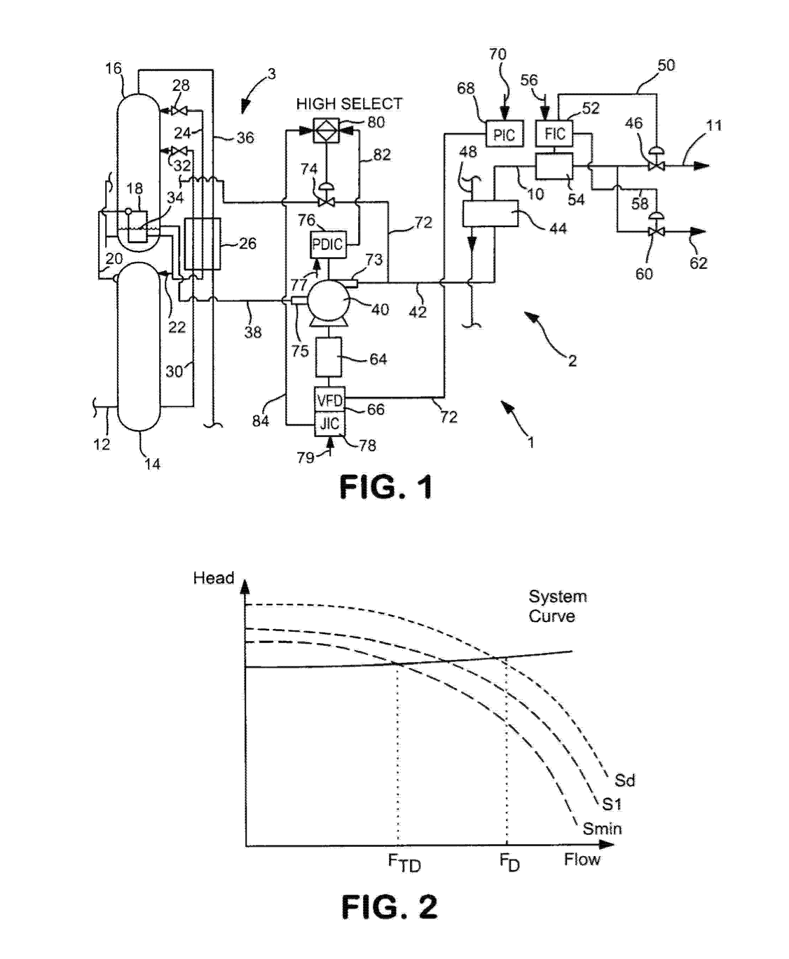

With reference to FIG. 1, pertinent parts of an air separation plant 1 are illustrated. Air separation plant 1 is designed to produce a pressurized product stream 10 with the use of a flow network 2 incorporating a control system to control the flow rate of pressurized product stream 10 and to deliver a product stream to a pipeline or one or more users as a product stream 11 at a constant delivery pressure. It is to be noted that although pressurized product stream 10 is discussed below with respect to a stream enriched in oxygen, the present invention would be equally applicable to a pressurized product stream enriched in nitrogen.

Air separation plant 1 incorporates a distillation column system 3 which for exemplary purposes is designed to operate in accordance with the well known Linde cycle. Although not illustrated, air separation plant 1 would have compression equipment such as main air compressor to compress the air, a pre-purifier to purify the air of higher boiling contaminants and a heat exchange system, typically, incorporating a parallel network of braised aluminum heat exchangers of plate-fin design. Such a heat exchange system cools the compressed and purified air stream to produce a feed stream 12 that is fed into the distillation column system 3. Again, although not illustrated, refrigeration would typically be imparted to the plant by boosting the pressure of an air stream, composed of the compressed and purified air, within a booster compressor and then expanding the boosted pressure stream in a turboexpander with the performance of work to generate an exhaust stream that would be fed into the distillation column system 3. Also not illustrated is a cold box that would enclose elements of the air separation plant 1 operating at cryogenic temperatures, for instance, the distillation column system 3.

In the illustrated air separation plant 1, the feed stream 12 is introduced into a high pressure column 14 that is operatively associated with a low pressure column 16 by means of a condenser reboiler 18 which is illustrated as a thermosiphon type of heat exchanger for exemplary purposes. The high and low pressure distillation columns 14 and 16 contain mass transfer contacting elements such as structured packing or trays or a combination of both that contact ascending vapor phases that become ever more rich in lighter components of the air, for instance nitrogen, with a descending liquid phase that become ever more rich with heavier components of the air, for instance oxygen. Within the high pressure column 14, a nitrogen-rich vapor column overhead is produced and a crude liquid oxygen-rich column bottoms also known as kettle liquid. A stream 20 of the nitrogen-rich vapor is removed from the high pressure column 14 and condensed in the condenser reboiler 18 to produce two liquid nitrogen-reflux streams 22 and 24 that reflux the high pressure column 14 and the low pressure column 16, respectively. Liquid nitrogen reflux stream 24 is subcooled within a subcooling unit 26 and then let down in pressure to the lower pressure of low pressure column 16 by means of a valve 28. It is to be noted that part of the liquid nitrogen reflux stream could be taken as a liquid product and in addition, could be pumped to produce a pressurized product stream 10. The refluxing of the columns initiates formation of the descending liquid phase. A crude liquid oxygen stream 30 composed of crude liquid oxygen is subcooled in subcooling unit 26, let down in pressure by a valve 32 and then introduced into the low pressure column 16 for further refinement. The distillation conducted within the low pressure column 16 produces an oxygen rich liquid column bottoms that is partially vaporized by the condenser reboiler 18 to initiate formation of the ascending vapor phase to produce residual oxygen-rich liquid 34 that is enriched in oxygen. A low pressure nitrogen stream 36 composed of column overhead of the low pressure column 16 can be partly warmed in subcooling unit 26 and then fully warmed to ambient through indirect heat exchange with the incoming compressed and purified air.

A liquid stream 38, composed of the oxygen-rich liquid 34 is pumped by a pump 40 located in the flow circuit 2 to produce a pressurized liquid stream 42. Pressurized liquid stream 42 is then heated in a heat exchanger 44 of the flow circuit 2 to produce pressurized product stream 10. As will be discussed, flow of the pressurized product stream 10 is controlled within the flow circuit 2 by means of a flow control valve 46 and a vent control valve 60. Pressure of the pressurized product stream 10 is controlled through control of the speed of pump 40 that is capable of operating at a variable speed. Depending upon the required pressure of pressurized product stream 10, heat exchanger 44 could be of braised aluminum plate-fin construction or, alternatively for high pressure applications, a spirally wound heat exchanger.

The control system used in controlling flow network 2 has three major objectives, namely, control of flow of the pressurized product stream 10, control of pressure of the pressurized product stream 10 and prevention of damage to the flow network and particularly to the heat exchanger 44 and pump 40 thereof. Turning first to flow control, flow control valve 46 and vent control valve 60 are motor operated or pneumatic valves and hence, are able to be remotely activated. Flow control valve 46 and vent control valve 60 are connected by means of electrical connections 50 and 58 to flow controller 52 (“FIC”). Flow controller 52 is responsive to a signal referable to flow of the pressurized product stream 10 as sensed by a flow meter 54 upstream of the flow control valve 46. Flow controller 52 is designed to maintain the flow rate of the pressurized product stream at a flow rate set point 56 which is an input to the flow controller 52. The flow rate set point 56 can be adjusted by means of software controlling plant operations of the air separation plant 1 between at least two levels, namely a design operational level and a turndown operational level. During the turndown operational level the flow rate of the pressurized product stream 10 is lower than that of the design operational level and the air separation plant produces the liquid stream 38 and therefore, the pressurized product stream 10, at a lower flow rate than during the design operation level. In both cases, however, the flow rate set point 56 has a value that is set to maintain a product purity of the pressurized product stream 10. Typically it is set as a ratio of the air flow rate entering the air separation plant 1. The flow rate in the illustrated embodiment can also be influenced by demand. As such, as demand drops, the production of the pressurized product stream will be reduced along with the magnitude of the set point 56.

In addition to the foregoing, a transitory decrease in demand can also influence the flow rate of the pressurized product stream 10. For example, where the pressurized product stream 10 is connected directly or indirectly to one or more users by being introduced into a pipeline or directly from the plant into customer installation, as demand for the pressurized product stream 11 decreases, the flow rate of the pressurized product stream 11 will also decrease. If the flow rate set point 56 is not updated, as demand drops, the flow control valve 46 will increasingly have to open in an attempt to maintain the flow at the flow rate set point 56 due to back pressure produced by the decrease in demand. A point, however, can be reached when the valve is wide open and the flow rate set point 56 will not be achieved through manipulation of flow control valve 46 alone. In order to remedy this, flow controller 52 is programmed to generate an electrical control signal that will be transmitted to the vent control valve 60 by an electrical connection 58 to open the vent control valve 60. The vent control valve 60 is located upstream of flow control valve 46 and when open, will produce a vent stream 62 containing a portion of the pressurized product stream 10 and thereby maintain the flow rate of the pressurized product stream 10 at the required flow rate set point 56. It is to be understood that in practice, the venting of product should be minimized and that the pressure and or flow of the pipeline feeding the customer will be monitored and used to adjust the air feed to the plant, and thus the flow rate set point 56 is set so that the need to vent is minimized. However, the time frame for such changes is typically longer than that of the control loops shown in FIG. 1.

As can be appreciated by those skilled in the art, flow controller 52 is preferably a readily obtainable digital device that can utilize proportional, integral, differential control or “PID” that is designed to produce an output control signal to adjust a valve and thereby maintain the flow control set point 56 which can be an analogue or digital signal. It is possible to use an analogue flow controller, also known in the art. Flow meter 54 can similarly be any number of readily obtainable devices that are compatible with the particular flow controller used. For instance, flow meter 54 could be an orifice plate type of device in which flow is indirectly obtained through measurement of pressure differential across the orifice.

In most operations, it is particularly important to control pressure of the pressurized product stream 10 so that a design pressure is maintained. This design pressure may in fact be a contractual requirement in a gas supply contract with a consumer. In any case, the control of pressure to maintain the design pressure of the pressurized product stream 10 is accomplished through variation of the speed of the pump 40 by means of varying the speed of the motor 64 driving pump 40 through a variable frequency drive 66. Motor 64 is an electric motor, for instance, a variable speed induction motor or possibly a permanent magnet motor. The variable frequency drive 66 in the typical case of an alternating current induction motor is another known device that is capable of varying motor input frequency and voltage of electrical power applied to the motor to vary speed of the motor in accordance with output requirements of the motor. As such, the variable frequency drive 66 also provides a controller that can be responsive to a signal, either analogue or digital to maintain the signal or value thereof in case of a digital signal at a value. In case of operations involving air separation plant 1, a pressure controller 68 (“PIC”) is provided which is preferably a digital device of the same type described above with respect to flow controller 56, but could also be analogue, to generate a speed control signal that is responsive to the measured pressure and that represents a pump speed designed to maintain a pressure set point at the design pressure regardless of flow. As is known in the art, pressure controller 68 can be an integrated device having a pressure transducer to sense the pressure of the pressurized product stream 10, downstream of heat exchanger 44, and then generates the control signal. Separate controller and pressure transducer arrangements can also be obtained. Such downstream sensing of pressure is advantageous in case of pressurized product stream having a supercritical pressure. However, where the pressurized product stream is a vapor, it is more advantageous to sense pressure upstream of the heat exchanger 44 because the presence of a phase change in the heat exchanger 44 can lessen the response of the pressure transmitter place downstream of the heat exchanger during transients.

The speed control signal produced by pressure controller 68 is referable to a required speed of the motor 54 and therefore, the pump 40, to maintain a pressure set point that is inputted into the pressure controller 68 by means of an analogue or digital signal 70. The signal is in turn transmitted to the variable speed drive 66 by means of an electrical connection 72 that is programmed to respond to the signal and adjust the speed of motor 64 and therefore the pump 40 in response to the signal. For instance, in case of turndown operational conditions, if no control action were taken, the pressure of pressurized product stream 10 would rise. In order to adjust the pressure to maintain the design pressure, the speed control signal generated by the pressure controller 68 would be referable to a speed of the motor 64 that would decrease and the variable frequency drive 66 would thereby control the speed of the motor 40 in accordance with such control signal at a decreased speed. The opposite would of course occur in a restoration of the pressure to design pressure of the pressurized product stream 10 from the turndown operational conditions to the design operational conditions of the air separation plant 1. In terms of programming the pressure controller 68, the control signal is produced by a tuned PID loop having an input of pressure and an output, by means of the speed control signal, speed. It is to be noted that in the above discussion, flow controller 52 maintains the flow rate of the pressurized product stream 10 at a flow rate set point input at 56 and the pressure of the pressurized product stream 10 is maintained at a design pressure as input at arrowhead 70. However, this maintenance is accomplished by a flow control valve 46 and vent control valve 60 and a variable speed motor 64 that are incapable of produce an immediate reaction to a divergence from the set point. Consequently, as would be appreciated by those skilled in the art, the term “maintain” as used herein and in the claims means to maintain a value within a targeted range. In this regard, there are two independent controlled variables, namely, flow rate and pressure. The pressure will react more rapidly than flow. Therefore, in order to prevent an unstable control system, it is preferable that the pressure controller 68 have a slower response than the flow controller 52. In more general terms it is preferable that the time domain of control of the pressure controller 68 be an order of magnitude slower that the flow controller 52.

A further point relates to the fact that speed adjustments of the electric motor 64 would not be instantaneous between the design operational conditions and the turndown operational conditions because the air separation plant 1 would not instantaneously reduce the output of the liquid stream 38. As such, both flow of the pressurized product stream 10 and adjustments to pressure by adjusting the speed of the motor 64 would be accomplished in an incremental fashion. Moreover, although the present invention has particular application to an air separation plant designed to have a variable output, it is understood that the present invention would have equal applicability to control of a plant intended for a constant output with slight changes in demand occasioned as a result of random environmental factors. In such a plant, the invention would be broadly applicable to controlling the plant so that the pressurized product stream is delivered at a constant design pressure and with the intent that the plant also delivers such product at a constant flow rate.

As mentioned above, there exists another object of control, namely, the prevention of damage; and this aspect centers around the prevention of damage to the pump 40. This damage can arise due to stall, a phenomenon commonly known in the art. The prevention of damage in such cases is accomplished by recirculating a portion of the pressurized liquid stream 72 from the outlet 73 of the pump 40 back to the inlet 75 of the pump 40. As illustrated, this recirculation can be indirect, namely, back to the low pressure column 16 and hence, back to the pump 40 by way of liquid stream 38. The control of such recirculation of liquid is accomplished by a recirculation control valve 74 that is activated either by a pressure differential indicating controller 76 (“PDIC”) or a motor power indicating controller 78 (“EC”). The pressure differential indicating controller 76 activates the recirculation control valve 74 when the pressure differential across the pump 40 is not compatible with safe and reliable operation of the pump to lower the discharge pressure of the pump 40. The pressure differential indicating controller 76 will generate a control signal to open recirculation control valve 74 in an amount to reduce the pressure differential when the pressure differential is above a set point defined for the pump 40. This pressure differential may be linked to the motor speed, that is the differential pressure that triggers the valve to open will increase with the speed of the pump. As will be discussed below, the pressure differential set point can also be linked to product flow requirements. In addition to the pressure differential indicating controller 76, a motor power indicating controller 78 is shown attached to the variable frequency drive 66. This controller can be used to offer additional protection beyond that offered by the PDIC controller. It is also used to activate recirculation control valve 74 when power drawn by the electric motor drops below a predefined value and at a minimum pump speed, encountered for instance, during turn down operating conditions, indicative that there is insufficient flow and that the pump 40 can be damaged due to a stall condition. In order to increase the flow under such circumstances, portion 72 of the pressurized liquid stream is recirculated. The motor power indicating controller 78 is programmed to generate a control signal that will open the recirculation control valve 74 to recirculate a sufficient flow rate of the portion 72 of the pressurized liquid to thereby increase the flow through the pump.

It is to be noted that both the pressure differential indicating controller 76 and the power indicating controller 78 are known devices that can be obtained from a variety of sources. A pressure differential indicating controller typically has an element to sense differential pressure, namely, the pressure differential between the outlet 73 and the inlet 75 of the pump 40, a controller which in response to a pressure differential set point which can be an input indicated by arrowhead 77 and the pressure differential generates a control signal to control valve 74. The motor power indicating controller 78 is connected to the variable frequency drive 66 and has an element to sense the power drawn by the motor 64. In response to the power drawn and a power set point as an input indicated by arrowhead 79, a control signal will be generated to control the opening of valve 74. The control signals generated by the pressure differential indicating controller 76 and the motor power indicating controller 78 are transmitted to a high select controller 80 by means of electrical conductors 82 and 84, respectively. The high select controller processes the control signal from each controller and selects the higher of the two to activate the control valve 74.

As has been mentioned above, the use of a control valve 74 is an expensive expedient that creates a point of failure in the air separation plant 1. Further, the recirculation of the portion 72 of the pressurized liquid stream is inefficient. Consequently such recirculation is to be minimized. In order to minimize this recirculation flow through the control valve 74 the operating characteristics of the pump 40 are carefully selected. With reference to FIG. 2, exemplary Pump Performance Curves (the dashed lines) at different speeds is illustrated for pump 40. Also shown is the System Curve representing the necessary pressure required to be delivered at the discharge of the pump. Note that while the pressure required at the customer use point may be constant, the head required to be delivered by the pump increases with flow to account for pressure drop in the lines to the delivery point. For systems where the delivery pressure is high, such as greater than 10 bara, this system curve will tend to be flat with flow since the pressure drop due to frictional losses in the system are small compared to the supply pressure. As shown in the drawing, at the intersection of the Pump Performance Curves and the System Curve, under design operating conditions, the design flow Fd is obtained at the design speed Sd. At the intersection of the System Curve and the minimum pump speed under turn down conditions, Smin, the flow rate at turn down Ftd is obtained. 51 is the pump speed at an intermediate speed and flow. It is to be noted that at the two speeds Smin and Sd, the head developed by the pump is virtually the same and the pressure output would be at a slightly higher pressure than the design pressure of the pressurized product stream 10 to overcome system resistance due to piping, heat exchanger 44 and valves. For this particular pump, the maximum head that can be delivered by the pump at a speed of Smin will be at zero flow. It is possible to have pumps designed such that the Pump Operating Curve exhibits a maximum delivered head at a flow greater than zero but this is not recommended. Further, in order to make the system stable and prevent recirculation, the pump 40 should be selected so that at a speed of Smin, this maximum pressure is at least 3 percent, if not greater, above the design pressure of the pressurized liquid stream. This reduces the sensitivity of flow delivered from the pump to perturbations in upstream pressure which could destabilize the control approach.

The variable frequency drive 66 is preferably programmed so that the motor 64 and hence, the pump 40 will not be operated below Smin. While it is possible that the air separation plant would be designed so that at a condition of maximum turndown, the air separation plant 1 would be capable of producing the pressurized product stream at a required flow rate and pressure at Smin, it is also possible that plant configurations would contemplate flow rates at which the particular pump were unable to produce a required flow rate of pressurized product stream at Smin. Specifically, in the latter case, control valve 46 would close to the extent necessary to produce the flow below design, but at Smin, the pump 40 would be delivering a flow of the pressurized liquid stream 42 that would cause a rise in pressure. In order to avoid this, the recirculation valve 74 is used to maintain the flow through the pump but reduce the flow to the heat exchanger by recirculating the portion of the pressurized liquid stream 72. The valve opening of the valve 74 can be controlled by one of or preferably both of the following. As mentioned above, the pressure differential indicating controller 76 is programmed with input 77 that represents a pressure differential set point of the pressure difference sensed by such controller between the outlet 73 and inlet 75 of pump 40. The control signal generated by the controller will open recirculation valve 74 when the pressure differential is above the pressure differential set point to allow portion 72 of the pressurized liquid stream to be recirculated in the recirculation path from the outlet 73 of pump 40 back to the low pressure column 16 and then to the inlet 75 of the pump 40. The pressure of the pressurized product stream 10 would be controlled indirectly, through control of the recirculation control valve 74 and control of the speed of the pump 40 as necessary. This pressure differential set point could be above a stall condition of the pump 40 where necessary to allow a sufficiently low flow rate of the pressurized product stream 10 to be produced at the design pressure and at a speed of Smin. The second control means is the use a motor power indicating controller 78 that monitors the power drawn by the motor 64 driving the pump 40. This controller will have a minimum power setting as a setpoint 79 such that when the power drawn by the motor approaches the setting, a signal will be sent to the recirculation control valve 74 to open so as to increase the flow through the pump. Optimally, both the power and pressure differential controllers are in place and the signal acting on the valve 74 will be chosen as the higher of the two signals using the high select controller 80. It is to be noted that the high select controller 80 is a known device that consists of a digital algorithm to select the highest signal. It is also possible to use an analogue signal selector, also known in the art. However, given that the air separation plant 1 will not be called upon to always deliver the product under conditions where recirculation is required, the use of recirculation is minimized.

While the present invention has been described with reference to preferred embodiments, as would occur to those skilled in the art, numerous changes, additions and omissions can be made to the embodiment illustrated and discussed above without departing from the spirit and scope of the present invention as set forth in the claims below.

We claim:

1. A method of delivering a pressurized product stream from an air separation plant comprising:
pumping a liquid stream to a design pressure while the liquid stream is at a cryogenic temperature, the liquid stream enriched in a component of air and produced through cryogenic distillation conducted within the air separation plant;
the liquid stream pumped with a pump driven by a variable speed motor having a speed regulated by a variable speed drive;
heating the liquid stream within a heat exchanger of the air separation plant to produce the pressurized product stream;
controlling flow rate of the pressurized product stream with a control valve located downstream of the heat exchanger so that a flow rate of the pressurized product stream upstream of the control valve is maintained at a flow rate set point and by also venting a portion of the pressurized product stream upstream of the flow control valve when the flow control valve is unable to control the flow of the pressurized product stream to achieve the flow rate set point;
measuring pressure of the liquid stream after having been pumped; and
controlling the speed of the variable speed motor and therefore, the pump with the variable speed drive in response to the pressure so that the pressure is maintained at the design pressure.

2. The method of claim 1, wherein:
the flow rate set point is set at a design operational level and alternatively, at a turndown operational level where the flow rate is lower than that of the design operational level and during which the air separation plant produces the liquid stream at a lower flow rate than during the design operation level; and
the speed of the pump during turndown is at a lower speed than the speed at the design operational level that is no less than a minimum speed where the pump is capable of pumping the liquid stream to a maximum pressure that is at least 3.0 percent above the design pressure.

3. The method of claim 2, wherein during the turndown operational level, where the pump is incapable of pumping the liquid stream at the design pressure while at the minimum speed, a portion of the liquid stream is recirculated from an outlet to an inlet of the pump in order to obtain the design pressure at the lower flow rate.

4. The method of claim 3, wherein the design pressure is a supercritical pressure and the pressure is measured within the pressurized product stream, downstream of the heat exchanger.

5. The method of claim 3, wherein the design pressure is below a supercritical pressure and the pressure is measured within the liquid stream, after having been pumped, upstream of the heat exchanger.

6. The method of claim 3, wherein the component is oxygen.

7. A delivery system for delivering a pressurized product stream from an air separation plant comprising:
a flow network comprising:
a pump to pump a liquid stream to a design pressure, the pump positioned within the air separation plant so that the liquid stream is pumped while at a cryogenic temperature;
the liquid stream enriched in a component of air and produced through cryogenic distillation conducted within the air separation plant;
a variable speed motor driving the pump;
a heat exchanger connected to the pump and located in the air separation plant to heat the liquid stream and thereby to produce the pressurized product stream;
a flow control valve located downstream of the heat exchanger;
a vent control valve located upstream of the flow control valve; and
a flow transducer located upstream of the flow control valve and configured to generate a flow signal referable to the flow rate; and
a control system comprising:
a flow controller responsive to the flow signal and the flow rate set point and configured to generate control signals to control the flow control valve so that a flow rate of the pressurized product stream upstream of the flow control valve is maintained at a flow rate set point and to control the vent control valve to vent a portion of the pressurized product stream when the flow control valve is unable to control the flow of the pressurized product stream to achieve the flow rate set point;
means for measuring pressure of the liquid stream after having been pumped;
means for generating a speed signal in response to the pressure and referable to a pump speed that will maintain the pressure at the design level; and
a variable speed drive responsive to the speed signal and configured to control the speed of the variable speed motor and therefore, the pump so that the pressure is maintained at the design pressure.

8. The delivery system of claim 7, wherein:
the flow controller has an input for the flow rate set point so that the flow rate set point is able to be varied between a design operational level and alternatively, at a turndown operational level where the flow rate is lower than that of the design operational level and during which the air separation plant produces the liquid stream at a lower flow rate than during the design operation level; and
the variable frequency drive has a minimum speed at which the pump is capable of pumping the liquid stream to a maximum pressure that is at least 3.0 percent above the design pressure and is responsive to speed signal so that during the turndown operational level the pump operates at a lower speed than at the design operational level but no less than the minimum speed.

9. The delivery system of claim 8, wherein:
a recirculation path, communicating between an outlet and an inlet of the pump, has a recirculation control valve that when open allows a portion of the liquid stream to recirculate from the outlet to the inlet of the pump;
a pressure differential indicator controller is responsive to a pressure difference between the outlet and an inlet of the pump and a pressure differential set point of the pressure difference and configured to generate a pressure difference control signal that will open the recirculation control valve when the pressure difference is above the pressure differential set point;
the pressure differential set point is selected such that the recirculation control valve opens to allow the pump to pump the liquid stream at the design pressure while at the minimum speed and at the lower flow rate of the turndown operational level;
a motor power indicating controller is: attached to the variable frequency drive; responsive to power drawn the by the motor while the pump is at minimum speed and a power set point of the power drawn by the pump; and configured to generate a power control signal that will open the recirculation control valve when the power drawn by the motor is below the power set point; and
a high select controller is positioned between the recirculation control valve and the pressure differential indicator controller and the motor power indicating controller and configured to select a higher value of the pressure difference control signal and the power control signal to control the recirculation control valve.

10. The delivery system of claim 9, wherein the design pressure is a supercritical pressure and the pressure measuring means is located within the flow network downstream of the heat exchanger.

11. The delivery system of claim 9, wherein the design pressure is below a supercritical pressure and the pressure measuring means is located within the flow network between the pump and the heat exchanger.

12. The delivery system of claim 1, wherein:
the pressure measuring means is a pressure transducer configured to generate a pressure signal referable to the pressure and the speed signal generating means is a pressure controller responsive to the pressure signal and configured to generate the speed signal;
the pressure controller has a slower response time than the flow controller; and
the variable speed drive is responsive to the speed signal so that the speed of the motor and therefore, the pump will vary in response to the speed signal to maintain the pressure at the design level.

13. The delivery system of claim 9, wherein:
the pressure measuring means is a pressure transducer configured to generate a pressure signal referable to the pressure and the speed signal generating means is a pressure controller responsive to the pressure signal and configured to generate the speed signal;
the pressure controller has a slower response time than the flow controller; and
the variable speed drive is responsive to the speed signal so that the speed of the motor and therefore, the pump will vary in response to the speed signal to maintain the pressure at the design level.

14. The delivery system of claim 9, wherein the component is oxygen.
